(19) United States
(12) Patent Application Publication
(10) Pub. No.: US 2025/0379372 A1
(43) Pub. Date: Dec. 11, 2025

(54) Conductive Terminal and Connector

(71) Applicant: Tyco Electronics (Shanghai) Co., Ltd., Shanghai (CN)

(72) Inventors: Chunjie Hu, Shanghai (CN); Tongbao (Tim) Ding, Shanghai (CN); Yongjian (Justin) Huang, Shanghai (CN); Zhimin Zhang, Shanghai (CN); Wenfang (Felix) Zhang, Shanghai (CN)

(73) Assignee: Tyco Electronics (Shanghai) Co., Ltd., Shanghai (CN)

(21) Appl. No.: 19/230,853

(22) Filed: Jun. 6, 2025

(30) Foreign Application Priority Data
Jun. 6, 2024 (CN) 202410733980.X

(51) Int. Cl. H01R 4/2425

(52) U.S. Cl. CPC H01R 4/2425

(57) ABSTRACT

A conductive terminal includes a body part, a first pair of blade elements extending from the body part and spaced apart from each other to form a first opening, a second pair of blade elements having a second opening aligned with and connected with the first opening, a size of the first opening is different than a size of the second opening, and a connecting element connecting the first pair of blade elements and the second pair of blade elements to form a U-shaped connection. The first pair of blade elements have a plurality of pairs of first convex angular portions. The plurality of pairs of first convex angular portions are arranged along a direction of the first opening and pierce an insulating layer of a wire so that the conductive terminal clamps the wire and an electrical connection is formed between the conductive terminal and the wire.

### CROSS-REFERENCE TO RELATED APPLICATIONS

This application claims the benefit of the filing date under 35 U.S.C. § 119(a)-(d) of Chinese Patent Application No. 202410733980.X, filed on Jun. 6, 2024.

### FIELD OF THE INVENTION

The present disclosure relates to the field of insulation displacement connector (IDC) technologies, and in particular, to a conductive terminal for connecting to a wire and a connector.

### BACKGROUND OF THE INVENTION

In the field of IDC technology, a conductive terminal of a connector is used for connecting to a wire. In the process of using the conductive terminal, the conductive terminal is pressed into the terminal frame holding the wire. The insulating layer of the wire is pierced by the conductive terminal, so that the conductive terminal can be electrically connected to the wire. The wire may be an electromagnetic wire, also referred to as a winding wire, which is an insulated wire used to manufacture a coil or a winding in an electrical product.

Enameled wire is one of the main varieties of electromagnetic wire, which usually includes a conductor and an insulating layer. Enameled wires include round enameled wires and flat enameled wires. The flat enameled wire is formed into a flat shape with a rectangular cross section. Compared to round enameled wires, flat enameled wires have higher power density and higher conductor filling rates. However, the conductive terminal in existing technologies is not applicable to a flat enameled wire.

### SUMMARY OF THE INVENTION

A conductive terminal includes a body part, a first pair of blade elements extending from the body part and spaced apart from each other to form a first opening, a second pair of blade elements having a second opening aligned with and connected with the first opening, a size of the first opening is different than a size of the second opening, and a connecting element connecting the first pair of blade elements and the second pair of blade elements to form a U-shaped connection. The first pair of blade elements have a plurality of pairs of first convex angular portions. The plurality of pairs of first convex angular portions are arranged along a direction of the first opening and pierce an insulating layer of a wire so that the conductive terminal clamps the wire and an electrical connection is formed between the conductive terminal and the wire.

### BRIEF DESCRIPTION OF THE DRAWINGS

Features, advantages, and other aspects of examples of the present disclosure will become more apparent with reference to the following detailed description taken in conjunction with the accompanying drawings, in which several examples of the present disclosure are shown by way of illustration rather than limitation.

FIG. 1 is a perspective view of a conductive terminal according to an example of the present disclosure;

FIG. 2 is a sectional front view of a connector in a connected state according to an example of the present disclosure;

FIG. 3A is a schematic diagram of a convex angular portion according to an example of the present disclosure;

FIG. 3B is a schematic diagram of a convex angular portion according to another example of the present disclosure;

FIG. 3C is a schematic diagram of a convex angular portion according to another example of the present disclosure;

FIG. 4 is a perspective view of a conductive terminal according to an example of the present disclosure;

FIG. 5 is a sectional perspective view of a conductive terminal according to an example of the present disclosure; and

FIG. 6 is a schematic cross-sectional view of a conductive terminal according to an example of the present disclosure.

### DETAILED DESCRIPTION

The following further describes the technical solutions of the present disclosure in detail with reference to the accompanying drawings by using examples. In the specification, the same or similar reference signs indicate the same or similar components. The following description of the examples of the present disclosure with reference to the accompanying drawings is intended to explain the general inventive concept of the present disclosure, and should not be construed as limiting the present disclosure.

The terms “including”, “comprising”, and similar terms used herein should be understood as open terms, that is, “including/including but not limited to” means that other contents may also be included. The term “based on” means “based at least in part on.” The term “one example” means “at least one example”. The term “another example” means “at least one additional example”, etc.

In applications employing IDC technology, such as automation devices, wireless devices, battery packs, lighting devices, etc., there is an increasing demand for low-voltage power supplies. Lower voltages require larger currents to deliver the required power, and thus larger wires to carry larger currents. In the same winding space, a flat enameled wire has a higher coil slot fullness and space volume rate than a round enameled wire, which can effectively reduce the resistance, so that the flat enameled wire can carry a larger current and thus can better adapt to high-current loads.

For the same cross-sectional area, the contact area between the round enameled wire and the conductive terminal is much smaller than the contact area between the flat enameled wire and the conductive terminal. For example, taking a round enameled wire with a diameter of 2 mm, in the case of the same cross-sectional area, the cross section of the flat enameled wire may be 3.49 mm on the long side and 0.9 mm on the short side. When the flat enameled wire enters the conductive terminal at the short side and the long side is in contact with the conductive terminal, the contact areas between the flat enameled wire and the round enameled wire with the conductive terminal may differ by a factor of 3. Therefore, in this case, the length of the insulation displacement groove of the conductive terminal needs to be adaptively extended. On this basis, due to the difference in cross-sectional shapes, although the conductive terminal with the insulation displacement groove being a smooth cutting edge is suitable for the round enameled wire, in the pierce process, the insulating layer at the long side of the flat enameled wire cannot be effectively pierced due to high resistance. Therefore, the conductive terminal in which the insulation displacement groove has a smooth cutting edge is not suitable for the flat enameled wire.

### Example 1

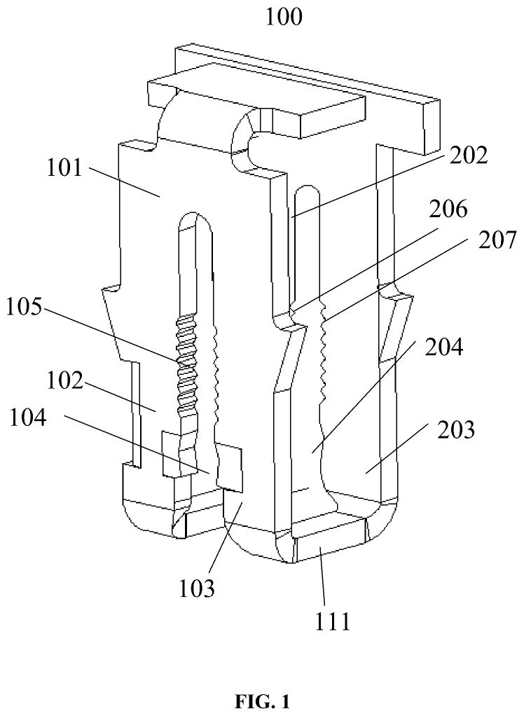

FIG. 1 is a front view of a conductive terminal 100 according to an example of the present disclosure. The conductive terminal 100 includes a body part 101, a first pair of blade elements 102, 103, a second pair of blade elements 202, 203, and a connecting element 111. The first pair of blade elements 102, 103 extends from the body part 101 to form a first opening 104 and is spaced apart from each other.

The connecting element 111 connects bottoms of the first pair of blade elements 102, 103 and the second pair of blade elements 202, 203 to form a U-shaped connection. As shown in FIG. 1, the connecting element 111 is 90 degrees from the body part 101. Two ends of the connecting element 111 are bent and connected to the lower ends of the first pair of blade elements 102, 103 and the second pair of blade elements 202, 203, respectively, to form a U-shaped structure.

The second pair of blade elements 202, 203 includes a second opening 204, which is aligned and connected with the first opening 104. Being aligned herein refers to that the centerlines of the two openings 104, 204 are aligned. The connectivity of the first opening 104 and the second opening 204 may allow wires to enter both openings. In the conductive terminal 100, the opposite arrangement of the first pair of blade elements 102, 103 and the second pair of blade elements 202, 203 as well as the first opening 104 and the second opening 204 can reduce the mechanical disturbance of the conductive terminal falling into a terminal frame, thus improving the stability of the connection between the conductive terminal and the wire.

It may be appreciated that, in some examples, the first pair of blade elements 102, 103 and the second pair of blade elements 202, 203 may be integrally formed. The conductive terminal 100 may be formed by stamping, bending, etc. In addition, the connecting element 111 may be other suitable structures bent and formed from the lower ends of the first pair of blade elements 102, 103, as long as the conductive terminal 100 is provided with other openings that are interconnected with the first opening 104 and that allow the wire to pass through both openings.

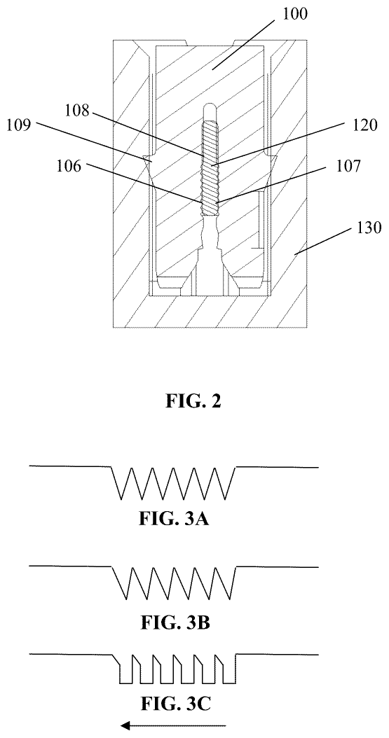

The first opening 104 is provided with oppositely disposed serrated regions 105. The serrated regions 105 include multiple pairs of first convex angular portions 106, 107, shown in FIG. 2, which are respectively disposed on opposite regions of the first pair of blade elements 102, 103. The pairs of first convex angular portions 106, 107 are configured to pierce the insulating layer of the wire, so that the conductive terminal 100 clamps the wire and an electrical connection with the wire is formed.

In the example of FIG. 1, the second pair of blade elements 202, 203 include multiple pairs of second convex angular portions 206, 207, respectively, disposed thereon, with the multiple second convex angular portions 206, 207 on each of the second pair of blade elements arranged along the direction of the opening 204.

The size of the opening 104, 204 includes one or more of an opening depth, an opening angle, a spacing of oppositely disposed convex angular portions, and a position of the convex angular portion in the opening. In some examples, the size of the second opening 204 and the size of the first opening 104 may be different. For example, the opening angles of the two openings may be different in order to accommodate different types of wires. For another example, the spacings of the two openings 104, 204 may be different in order to accommodate wires of a same type but with different wire diameters. Specifically, the spacing between oppositely disposed convex angular portions of the second opening 204 may be greater than or less than the spacing between oppositely disposed convex angular portions of the opening 104 in FIG. 1. Such different sizes can make the conductive terminal 200 adapt to wires with different diameters. For another example, the first opening 104 of the conductive terminal includes multiple pairs of first convex angular portions 106, 107, while the second opening 204 is a smooth structure.

In the example of FIG. 1, the top of the body part 101 is bent to an angle perpendicular to the first pair of blade elements 102, 103. Such an arrangement can improve the stability of the conductive terminal in the blanking process. It may be understood that “first” and “second” in the first pair of blade elements and the second pair of blade elements in FIG. 1 are merely for distinguishing, and are not intended to be limiting. For example, the blade elements 202, 203 in FIG. 1 may be the first pair of blade elements, while the blade elements 102, 103 may be the second pair of blade elements. The blade elements 202, 203 include multiple pairs of convex angular portions for piercing the insulating layer of the wire, while the opening 104 of the blade elements 102, 103 may include multiple pairs of convex angular portions/be a smooth structure.

When the wire is a flat enameled wire, in the process of clamping the wire by the conductive terminal, the wire is first placed in the groove of the terminal frame. Then, the conductive terminal is inserted into the terminal frame. In this process, the pairs of convex angular portions in the uneven insulation displacement groove (only the first opening 104 or the first opening 104 and the second opening 204 together) of the conductive terminal pierce the insulating layer of the wire, ultimately bringing the conductive terminal into contact with the conductor portion of the wire to achieve conduction.

In some other examples, the size of the first opening 104 and the size of the second opening 204 may be equal. For example, the opening depth, the opening angle, the distance between oppositely disposed convex angular portions, and the position of the convex angular portion in the openings are the same. In this way, the wire can be in balanced contact with the second pair of blade elements and the first pair of blade elements. In addition, this arrangement of the same opening size can multiply the contact area between the conductive terminal and the wire, thereby reducing the contact resistance, so that the conductive terminal 100 is more suitable for the case where the wire carries a large current.

Compared with the general case where the insulation displacement groove is of a smooth structure, the convex angular portions 106, 107 of the serrated regions 105 of the opening 104 and/or the convex angular portions 206, 207 of the serrated regions 206 of the opening 204 in FIG. 1 can pierce the rectangular outer edge of the flat enameled wire with less resistance, thereby allowing the flat enameled wire to enter the openings in a suitable position to form a stable electrical connection with the conductive terminal. Therefore, the conductive terminal 100 in FIG. 1 may be applicable to a case in which the enameled wire is flat. Since the volume ratio of flat wire is increased in the winding space, the size of the corresponding motor can be reduced, thus saving space and improving productivity.

It may be understood that the conductive terminal 100 provided in FIG. 1 may be applicable not only to the flat enameled wire, but also to the round enameled wire. For the same type of conductive terminal, it is possible to apply not only the flat enameled wire to match, but also to up to three round enameled wires, where the diameter of the round enameled wire is approximately the size of the short side of the cross-section of the flat enameled wire.

In some examples, the opening depths and the opening shapes of the first opening 104 and the second opening 204 are the same, that is, the two openings are only different in the spacing of the convex angular portions. The first opening 104 on the first pair of blade elements 102, 103 is illustrated only as an example. Various arrangements on the first opening 104 may be applied to the second opening 204 as well, as will not be described below.

In the example of FIG. 1, each pair of convex angular portions 106, 107 on each of blade elements 102, 103 is evenly arranged along the direction of the first opening 104, i.e., the spacing between adjacent convex angular portions on the same blade element is the same. In addition, each pair of convex angular portions 106, 107 of the multiple pairs of convex angular portions is horizontally disposed in the width direction of the pair of blade elements. The width direction here refers to the width direction of the blade element in the extension plane thereof. In this way, each pair of convex angular portions 106, 107 may cooperatively pierce the insulating layer of the wire and evenly force both sides of the wire in contact with the blade elements.

Different arrangements of the pairs of convex angular portions only need to pierce the insulating layer of the flat enameled wire. In some examples, the spacing of adjacent convex angular portions on each blade element may be unequal, or the size of each convex angular portion may be unequal. In some examples, each pair of convex angular portions 106, 107 may be staggered in the width direction of the pair of blade elements.

In the example of FIG. 1, the blade elements 102, 103 extend in parallel and the opening 104 is a U-shaped opening with equal distance between each pair of convex angular portions 106, 107. In this way, when the wire is clamped by the conductive terminal, a part of the wire that first extends into the opening and a part of the wire that later extends into the opening are uniformly stressed. Therefore, the reliability of the connection between the wire and the conductive terminal is high. In some other examples, the blade elements 102, 103 extend at an angle, and the distances between each pair of convex angular portions 106, 107 vary with the extending direction of the blade elements 102, 103, for example, gradually increasing. The opening 104 is in an inverted V-shape. This structure allows for more types of conductive terminals.

In this example, the spacing of the convex angular portions in the conductive terminal may be determined based on the cross-sectional size of the wire. For example, when the wire is a flat enameled wire, the spacing of each pair of convex angular portions is less than the short side of the cross section of the wire. In this way, after the flat enameled wire enters the opening of the conductive terminal at the short side of the cross section, since the distance between each pair of convex angular portions is less than the short side of the cross section, it helps remove the insulating layer outside the wire.

In this example, the lengths of the pairs of convex angular portions, i.e., the lengths of the serrated regions, may also be determined based on the cross-sectional size of the wire and the insertion position of the wire. In some examples, the length of the pairs of convex angular portions may be greater than the long side of the cross-section of the wire. The serrated regions 105 may occupy most of the area of the opening 104. Correspondingly, the final insertion position of the wire is in the middle of the serrated regions 105. In some other examples, the length of the pairs of convex angular portions may be less than or equal to the long side of the cross-section of the wire, with a portion of the final insertion position of the wire being in the serrated regions 105 and the other portion being in a region on the opening 104 other than the serrated regions 105.

For example, the pair of blade elements 102, 103 also includes oppositely disposed smooth portions 108, shown in FIG. 2. The smooth portions 108 are located above the pairs of convex angular portions 106, 107 in the extending direction of the pair of blade elements. The smooth portions 108 and at least part of the pairs of convex angular portions 106, 107 are collectively configured to be in contact with the wire. FIG. 2 shows a schematic diagram in which the wire is in contact with the conductive terminal.

FIG. 2 is a schematic diagram that shows a connection state between the conductive terminal 100 and the wire 120 according to an example of the present disclosure. In FIG. 2, the wire 120 enters the conductive terminal 100 at a short side and is pierced and clamped by the conductive terminal 100. The conductive terminal 100 and the wire 120 are fixed in the terminal frame 130. In the shown embodiment, the wire 120 is pierced by the convex angular portions 106, 107 of the conductive terminal 100, and is clamped jointly by the convex angular portions 106, 107 and the smooth portions 108. Compared with the case where all of the wire 120 is in contact with the convex angular portions, the arrangement of the smooth portions 108 can increase the contact area between the wire 120 and the conductive terminal 100. In addition, the smooth portions 108 can also provide a holding force so that the wire 120 is more securely clamped.

In the embodiment of FIGS. 1-2, the spacing of the smooth portions 108 is equal to the spacing of the convex angular portions 106, 107, i.e., the distance between each pair of the pairs of convex angular portions. The convex angular portions may be formed by downward stamping by a machining tool along the thickness direction of the conductive terminal 100. In other examples, the spacing of the smooth portions 108 may be greater than the distance between each pair of the pairs of convex angular portions. In this way, the smoothing portions reduce the internal stress on the conductor portion of the wire when it contacts the conductor portion, and reduce the deformation of the wire to ensure a good electrical connection reliability.

As shown in FIG. 2, each of the first/second pair of blade elements also includes a barb structure 109 disposed on the outside of each blade element, and its position corresponds to the position of the pairs of convex angular portions. The barb structure 109 is subjected to the downward force of the terminal frame 130 in the terminal frame 130, which can ensure that the lowermost region of the wire 120 is held in place.

In the example shown in FIG. 1, the convex angular portion 106, 107 has a fine sawtooth shape, but the shape of the convex angular portion 106, 107 is not limited thereto. In some examples, the convex angular portion 106, 107 is shaped in one or more of an equilateral triangle, an oblique triangle, and a right-angle trapezoid on the extension plane of the pair of blade elements.

FIG. 3 shows a schematic diagram of convex angular portions 106, 107 according to an example of the present disclosure. In FIG. 3A, the convex angular portion is shaped in an equilateral triangle, in which an angle of the protrusion is perpendicular to the opening direction. In FIG. 3B, the convex angular portion is shaped in an oblique triangle. In FIG. 3C, the convex angular portion is shaped in a right-angle trapezoid. The edges of the convex angular portions of FIG. 3B to FIG. 3C are all at a certain angle with the opening, so that the convex angular portions obliquely pierce the insulating layer at a certain acute angle along the cutting direction (shown by the arrow) during the contact of the conductive terminal 100 with the wire 120, which is easier to pierce the wire 120.

### Example 2

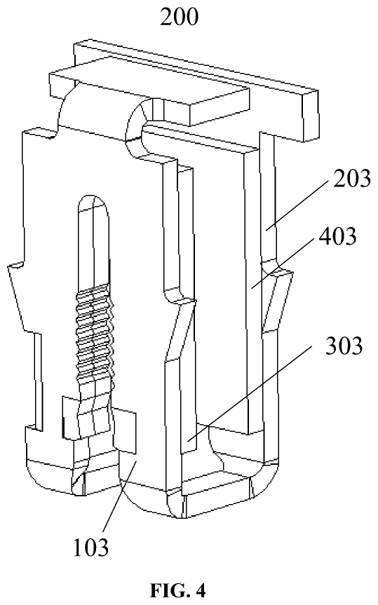

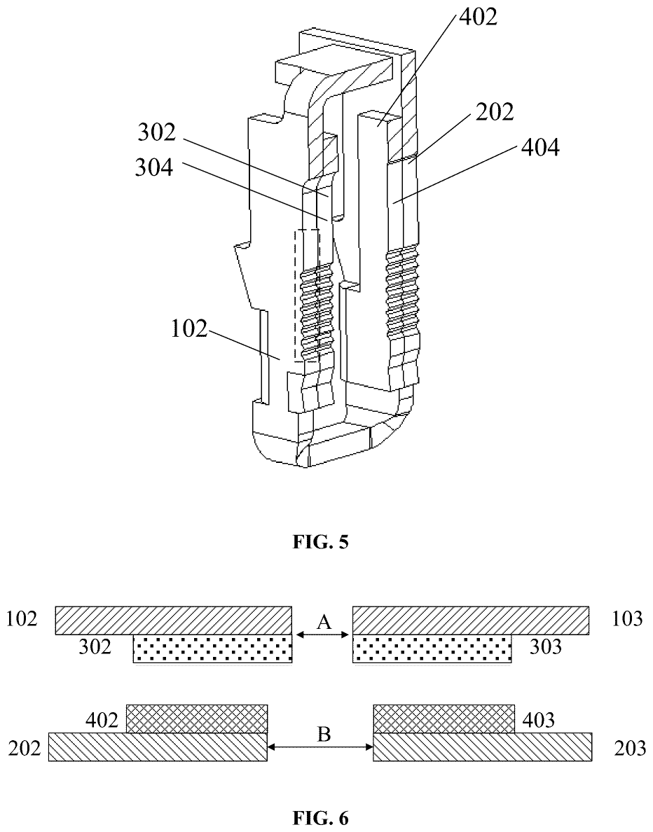

FIGS. 4-5 illustrate a perspective view and a sectional perspective view of a conductive terminal 200 according to another embodiment of the present disclosure. Compared with the conductive terminal 100 of FIG. 1, the conductive terminal 200 is a 4-layer structure. Specifically, in the conductive terminal 200, a third pair of blade elements 302, 303 are overlapped on the first pair of blade elements 102, 103, while a fourth pair of blade elements 402, 403 are overlapped on the second pair of blade elements 202, 203. In the shown embodiment, the third pair of blade elements 302, 303 are stacked with the first pair of blade elements 102, 103 in the thickness direction of the conductive terminal 200. The third pair of blade elements 302, 303 includes a third opening 304. The third opening 304 includes multiple pairs of third convex angular portions respectively disposed thereon. The third opening 304 is aligned with the first opening 104. The fourth pair of blade elements 402, 403 is stacked with the second pair of blade elements 202, 203 in the thickness direction of the conductive terminal 200. The fourth pair of blade elements 402, 403 includes a fourth opening 404. The fourth opening 404 includes multiple pairs of fourth convex angular portions respectively disposed thereon. The fourth opening 404 is aligned with the first opening 104. Being aligned herein refers to that the centerlines of the two openings are aligned. In addition, the first opening 104 and the third opening 304 are equal in size, while the second opening 204 and the fourth opening 404 are equal in size. The pairs of convex angular portions on each opening are configured to pierce the insulating layer of the wire, thereby causing the conductive terminal 200 to clamp the wire and form an electrical connection between the conductive terminal and the wire.

In some examples, stacked blade elements may be connected by a bent connection portion. In some other examples, stacking may also be implemented in other ways, such as riveting.

In the embodiment of FIGS. 4 and 5, each pair of blade elements extends in parallel. Convex angular portions on the blade element on each layer of the structure are uniformly arranged along the direction of the opening. Adjacent convex angular portions are equally spaced. Each pair of the pairs of convex angular portions is horizontally disposed in a width direction of the pair of blade elements. Each pair of blade elements also includes oppositely disposed smooth portions. The smooth portions are positioned above the pairs of convex angular portions. The smooth portions and the pairs of convex angular portions are jointly configured to contact the wire.

The size of the opening includes one or more of an opening depth, an opening angle, a distance between oppositely disposed convex angular portions, and a position of the convex angular portion in the opening. In some examples, each layer's opening size may be set according to actual needs. For example, each layer's opening size may be the same. When each layer's opening size is the same, for example, when the distances of opposite convex angular portions on each layer of the structure of the conductive terminal 400 are equal, the contact area of the wire (i.e., the part of the dotted box in FIG. 5) is increased up to four times as much as it was originally when compared to a single layer of the structure (e.g., the conductive terminal 100 in FIG. 1), which helps for applying a situation in which the wire is carrying a large electric current.

In some examples, the size of the openings in each layer of the conductive terminal 200 may be different. More specifically, the spacing between the opposing convex angular portions or smooth portions of the second/fourth openings 204/404 is greater than the spacing between the opposing convex angular portions or smooth portions of the first/third openings 104/304. Such different sizes can make the conductive terminal 200 adapt to wires with different diameters. For example, FIG. 6 illustrates a lateral cross-sectional view of the conductive terminal 200 according to an embodiment of the present disclosure.

In FIG. 6, the opening size of the first pair of blade elements 102, 103 and the opening size of the third pair of blade elements 302, 303 are the same as A. The opening size of the second pair of blade elements 202, 203 and the opening size of the fourth pair of blade elements 402, 403 are the same as B. A is less than B. In this example, the conductive terminal may be applicable to the wires with wire diameters approximately ranging from A-B. For example, A is 0.5 mm, B is 0.8 mm, and the conductive terminal may be adapted to all wires having a wire diameter in a range of 0.6 mm to 0.9 mm. In this way, a certain type of conductive terminal 200 can be applied to wires with different wire diameters. In an application scenario of wires with different wire diameters, the conductive terminal does not need to be replaced in the blanking process, thereby improving connection efficiency and reducing costs. In some examples, the opening sizes of each layer may be arbitrarily combined, for example, the opening sizes of each layer are different.

The stacked structure of the conductive terminal may be freely combined. For example, in other embodiments, the stacked structure of the conductive terminal may be a 3-layer structure, that is, on the basis of the conductive terminal 100, one of the first pair of blade elements and the second pair of blade elements is overlapped with an additional layer of blade element, and the other is not overlapped with an additional blade element. Alternatively, on the basis of the conductive terminal 100, multiple layers may be overlapped in the first pair of blade elements and the second pair of blade elements. The number of stacked layers may be the same or different in other embodiments.

Another embodiment of the present disclosure further discloses a connector, including a conductive terminal and a socket for use with the conductive terminal, where the socket is, for example, the terminal frame 130 in FIG. 2. The conductive terminal in the connector may be any one of the above conductive terminals or a combination thereof.

The foregoing descriptions are merely optional examples of this present disclosure, and are not intended to limit the examples of this present disclosure. Various modifications and changes may be made to the examples of this present disclosure by a person skilled in the art. Any modification, equivalent replacement, or improvement made without departing from the spirit and principle of the examples of the present disclosure shall be included in the protection of the examples of this present disclosure.

Although the examples of the present disclosure have been described with reference to several specific examples, it should be understood that the examples of the present disclosure are not limited to the disclosed specific examples. The examples of the present application are intended to cover various modifications and equivalent arrangements included within the spirit and scope of the appended claims. The scope of the appended claims is to be accorded the broadest interpretation so as to encompass all such modifications and equivalent structures and functions. CLAIMS

1. A conductive terminal for connecting to a wire, comprising:
a body part;
a first pair of blade elements extending from the body part and spaced apart from each other to form a first opening, the first pair of blade elements have a plurality of pairs of first convex angular portions respectively disposed thereon, the plurality of pairs of first convex angular portions are arranged along a direction of the first opening and pierce an insulating layer of the wire so that the conductive terminal clamps the wire and an electrical connection is formed between the conductive terminal and the wire;
a second pair of blade elements having a second opening aligned with and connected with the first opening, a size of the first opening is different than a size of the second opening; and
a connecting element connecting the first pair of blade elements and the second pair of blade elements to form a U-shaped connection.

2. The conductive terminal of claim 1, wherein the second pair of blade elements has a plurality of pairs of second convex angular portions respective disposed thereon, the plurality of pairs of second convex angular portions are arranged along a direction of the second opening.

3. The conductive terminal of claim 2, wherein a spacing of the plurality of pairs of first convex angular portions and a spacing of the plurality of pairs of second convex angular portions are different.

4. The conductive terminal of claim 3, wherein the first opening and the second opening are equal in opening depth and opening shape.

5. The conductive terminal of claim 1, wherein the first convex angular portions on each of the first pair of blade elements are uniformly arranged along a direction of the first opening.

6. The conductive terminal of claim 5, wherein each pair of the first convex angular portions is horizontally arranged in a width direction of the first pair of blade elements.

7. The conductive terminal of claim 1, wherein the first pair of blade elements has a plurality of smooth portions that are oppositely disposed.

8. The conductive terminal of claim 7, wherein the smooth portions are positioned above the plurality of pairs of first convex angular portions in an extension direction of the first pair of blade elements, the smooth portions and the plurality of pairs of first convex angular portions jointly contact the wire.

9. The conductive terminal of claim 8, wherein a spacing of the smooth portions is greater than or equal to a spacing of the plurality of pairs of first convex angular portions.

10. The conductive terminal of claim 1, wherein the plurality of pairs of first convex angular portions on an extension plane of the first pair of blade elements are shaped in at least one of an equilateral triangle, an oblique triangle, and a right-angle trapezoid.

11. The conductive terminal of claim 1, wherein a spacing of the plurality of pairs of first convex angular portions is less than a short side of a cross section of the wire.

12. The conductive terminal of claim 11, wherein a length of the plurality of pairs of first convex angular portions is less than or equal to a long side of the cross section of the wire.

13. The conductive terminal of claim 1, wherein a plurality of distances between the plurality of pairs of first convex angular portions are equal.

14. The conductive terminal of claim 1, wherein a plurality of distances between each pair of the plurality of pairs of first convex angular portions vary in an extension direction of the first pair of blade elements.

15. The conductive terminal of claim 2, wherein the first pair of blade elements and the second pair of blade elements each have a barb structure that is disposed on an outside of the first pair of blade elements and the second pair of clade elements.

16. The conductive terminal of claim 15, wherein a position of the barb structure corresponds to a position of the plurality of pairs of first convex angular portions and a position of the plurality of pairs of second convex angular portions.

17. The conductive terminal of claim 2, further comprising a third pair of blade elements stacked with the first pair of blade elements in a thickness direction of the conductive terminal, the third pair of blade elements has a third opening and a plurality of pairs of third convex angular portions.

18. The conductive terminal of claim 17, wherein the third opening is aligned with the first opening and a size of the third opening is equal to a size of the first opening.

19. The conductive terminal of claim 17, further comprising a fourth pair of blade elements stacked with the second pair of blade elements in the thickness direction, the fourth pair of blade elements have a fourth opening and a plurality of pairs of fourth convex angular portions, the fourth opening is aligned with the second opening and a size of the fourth opening is equal to a size of the second opening.

20. A connector, comprising:
a conductive terminal including:
a body part;
a first pair of blade elements extending from the body part and spaced apart from each other to form a first opening, the first pair of blade elements have a plurality of pairs of first convex angular portions respectively disposed thereon, the plurality of pairs of first convex angular portions are arranged along a direction of the first opening and pierce an insulating layer of the wire so that the conductive terminal clamps the wire and an electrical connection is formed between the conductive terminal and the wire;
a second pair of blade elements having a second opening aligned with and connected with the first opening, a size of the first opening is different than a size of the second opening; and
a connecting element connecting the first pair of blade elements and the second pair of blade elements to form a U-shaped connection.
